(19) United States
(12) Patent Application Publication
(10) Pub. No.: US 2026/0170528 A1
(43) Pub. Date: Jun. 18, 2026

(54) INCENTIVE-DRIVEN USER ENGAGEMENT SYSTEM

(71) Applicant: eBay Inc., San Jose, CA (US)

(72) Inventors: Shyamsundar Venkata Eranky, San Jose, CA (US); Usha Achladi, San Jose, CA (US); Goutham Rangaswamy, San Jose, CA (US); RAVINDRAKUMAR BHARATBHAI SAVALIYA, SAN JOSE, CA (US); Badal Bhupendrakumar Shah, Newark, CA (US)

(21) Appl. No.: 18/984,058

(22) Filed: Dec. 17, 2024

(51) Int. Cl. G06Q 30/0207; G06Q 30/0204; G06Q 30/0601

(52) U.S. Cl. CPC G06Q 30/0224; G06Q 30/0204; G06Q 30/0631

(57) ABSTRACT

A method for a publication platform involves identifying users and their corresponding metrics, classifying users based on their likelihood to respond to incentives, identifying a targeted user group, identifying items published by a user, selecting a set of items based on management rules, generating a pluggable interface component providing a consistent recommendation interface across different device operating systems, receiving attribute values of a custom incentive signal from the user, and sending a message based on the custom incentive signal to the targeted user group.

### TECHNICAL FIELD

This disclosure relates to a method for personalized incentive recommendations in publication platforms across diverse devices. In particular, the present application relates to a pluggable component that provides a consistent user experience across various devices.

### BACKGROUND

In conventional recommendation systems, providers face significant challenges in efficiently managing and delivering targeted recommendations to users. These systems often require providers to manually review individual items and make decisions about potential incentives, which becomes increasingly impractical as inventory sizes grow.

Additionally, existing solutions typically scatter recommendations across various interfaces, requiring custom integration for each touchpoint and creating inconsistent user experiences. The dispersed nature of these recommendations leads to low adoption rates and reduced efficiency. Current systems also lack sophisticated mechanisms for categorizing users resulting in non-targeted recommendations that yield lower conversion rates. Furthermore, traditional implementations require extensive coding efforts for each interface integration, making it difficult to maintain consistency across different platforms and devices. These limitations create substantial technical barriers to implementing effective, scalable recommendation systems that can efficiently process large volumes of data while maintaining a consistent user experience across multiple platforms.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 is a block diagram illustrating a marketplace application that, in one example embodiment, is provided as part of a networked system.

FIG. 3 is a block diagram illustrating a pluggable recommendation system, in accordance with one example embodiment.

FIG. 4 is a flow diagram illustrating a method for a pluggable recommendation system, in accordance with another example embodiment.

FIG. 5 is a block diagram illustrating an example operation of the pluggable recommendation system, in accordance with one example embodiment.

FIG. 6 illustrates banner user interfaces in accordance with example embodiments.

FIG. 7 illustrates a user interface in accordance with one example embodiment.

FIG. 8 illustrates a message user interface in accordance with one example embodiment.

FIG. 9 illustrates a message user interface in accordance with one example embodiment.

FIG. 10 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The present invention relates to systems and methods for providing targeted recommendations through a unified and flexible technical infrastructure. More specifically, the invention addresses critical technical challenges in processing and delivering recommendations across multiple platforms while maintaining system efficiency and data consistency

In conventional systems, the technical infrastructure suffers from significant limitations in processing large volumes of user interaction data, requiring resource-intensive manual review processes and creating substantial computational overhead. These systems typically employ fragmented architectures that necessitate separate codebases and integration points for each interface touchpoint, leading to increased technical debt and system maintenance challenges. Furthermore, existing solutions struggle with maintaining data consistency and real-time synchronization across multiple platforms, resulting in degraded system performance and increased latency in recommendation delivery.

To address these technical challenges, the invention implements a sophisticated data processing architecture comprising multiple integrated Components. At its core, the system includes a data analyzer that employs advanced algorithms to process user-related data points and automatically categorize users based on their response likelihood. This Component significantly reduces computational overhead by eliminating the need for manual data review processes.

The invention's technical infrastructure is built around a centralized recommendation platform that aggregates data and manages recommendations through an automated lifecycle management system. This centralized architecture ensures real-time synchronization and consistent performance across platforms while minimizing system latency. The platform incorporates automated rule creation capabilities and dynamic recommendation adjustment mechanisms, enabling efficient processing of large data volumes.

One feature of the present application is a pluggable interface Component, designed to be seamlessly integrated across different native device interfaces with minimal coding effort. This Component eliminates the need for custom integration at each touchpoint, significantly reducing technical debt and system maintenance requirements. The interface Component automatically handles different call-to-action behaviors and updates with new recommendations without requiring backend integration, providing a scalable solution for cross-platform deployment.

The system further implements an automated lifecycle management mechanism that handles recommendation actions including dismissal, temporary disabling, and adoption of recommendations. This automation reduces computational overhead while ensuring efficient data processing and recommendation delivery. The technical architecture also supports the continuous identification of opportunities through automated monitoring and analysis of system metrics, enabling real-time optimization of recommendation delivery.

In one example, the method identifies users on a publication platform, analyzes metrics, classifies users by their likelihood to respond to incentives, and targets a group with high response potential. It creates a pluggable interface component for different devices, integrates item recommendations, and sends tailored messages to the targeted user group. This method addresses issues like inefficient data processing, system fragmentation, and resource management, reducing the need for repetitive searches and saving computing resources.

In one example embodiment, a method includes identifying a plurality of users of a publication platform and metrics corresponding to the plurality of users, classifying each user of the plurality of users by determining a likelihood to respond signal to an incentive signal for each user of the plurality of users based on the metrics, identifying a targeted user group from the plurality of users based on the classifying, identifying a plurality of items published by a first user of the publication platform, identifying, from the plurality of items, a set of items based on item management rules set by the first user, generating a pluggable interface component that integrates across different native device operating systems and provides a recommendation user interface of the publication platform consistent across different systems of a device of the first user, the pluggable interface component identifying the set of items, an incentive template for the targeted user group, the incentive template indicating a custom incentive signal, attributes of the custom incentive signal, receiving, from the first user via the incentive template, attribute values of the custom incentive signal, generating a message, via the publication platform, based on the attribute values of the custom incentive signal, and sending, via the publication platform, the message to the targeted user group.

As a result, one or more of the methodologies described herein facilitate solving the technical problems of inefficient data processing architecture, system architecture fragmentation, data synchronization, interface integration complexity, and computational resource management. As such, one or more of the methodologies described herein may obviate a need for certain efforts or computing resources that otherwise would be involved in client devices leaving a listing for an item and continually performing search queries for other listings of the item without knowledge of hidden attributes. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

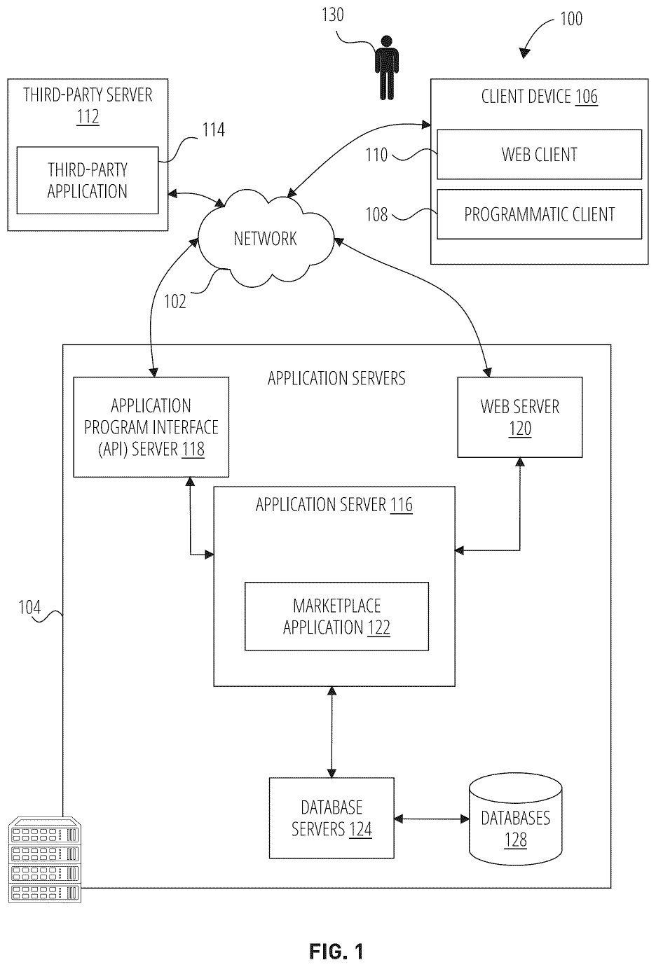

FIG. 1 is a diagrammatic representation of a network environment 100 in which some example embodiments of the present disclosure may be implemented or deployed. One or more application servers 104 provide server-side functionality via a network 102 to a networked user device, in the form of a client device 110. A web client 110 (e.g., a browser) and a programmatic client 108 (e.g., an “app”) are hosted and execute on the web client 110.

An Application Program Interface (API) server 118 and a web server 120 provide respective programmatic and web interfaces to application servers 104. A specific application server 116 hosts a marketplace application 122, which includes Components, modules and/or applications.

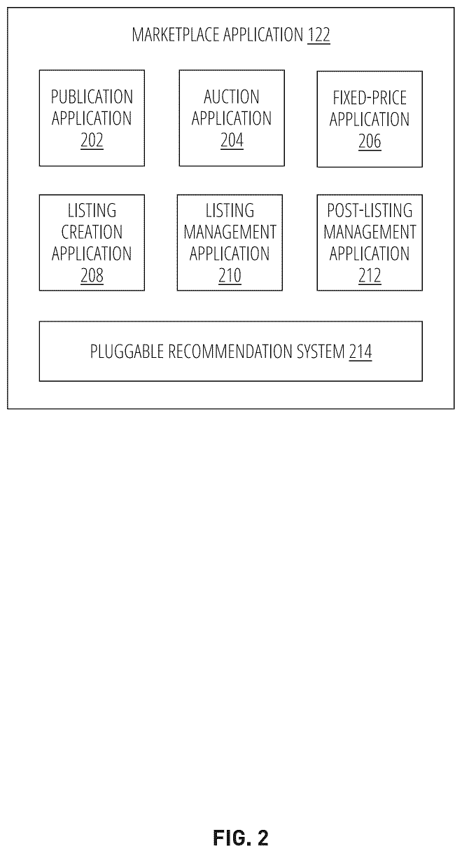

The marketplace application 122 may provide a number of marketplace functions and services to users who access the application servers 104. The marketplace application 122 includes, for example, a publication platform that enables users to publish listings. The marketplace application 122 is described in more detail below with respect to FIG. 2.

Further, while the network environment 100 shown in FIG. 1 employs a client-server architecture, the embodiments are, of course, not limited to such an architecture, and could equally well find application in a distributed, or peer-to-peer, architecture system, for example. The marketplace application 122 can also be implemented as standalone software programs, which do not necessarily have networking capabilities.

The web client 110 accesses the various marketplace application 122 via the web interface supported by the web server 120. Similarly, the programmatic client 108 accesses the various services and functions provided by the marketplace application 122 via the programmatic interface provided by the Application Program Interface (API) server 118. The programmatic client 108 may, for example, be a seller application (e.g., eBay Application developed by eBay Inc., of San Jose, California) to enable sellers to author and manage listings on the network environment 100 in an offline manner and to perform batch-mode communications between the programmatic client 108 and the application servers 104.

FIG. 1 also illustrates a third-party application 114 executing on a third-party server 112 as having programmatic access to the application servers 104 via the programmatic interface provided by the Application Program Interface (API) server 118. For example, the third-party application 114 may, utilizing information retrieved from the application server 116, support one or more features or functions on a website hosted by a third party. The third-party website may, for example, provide one or more promotional, marketplace, or payment functions that are supported by the relevant applications of the application servers 104.

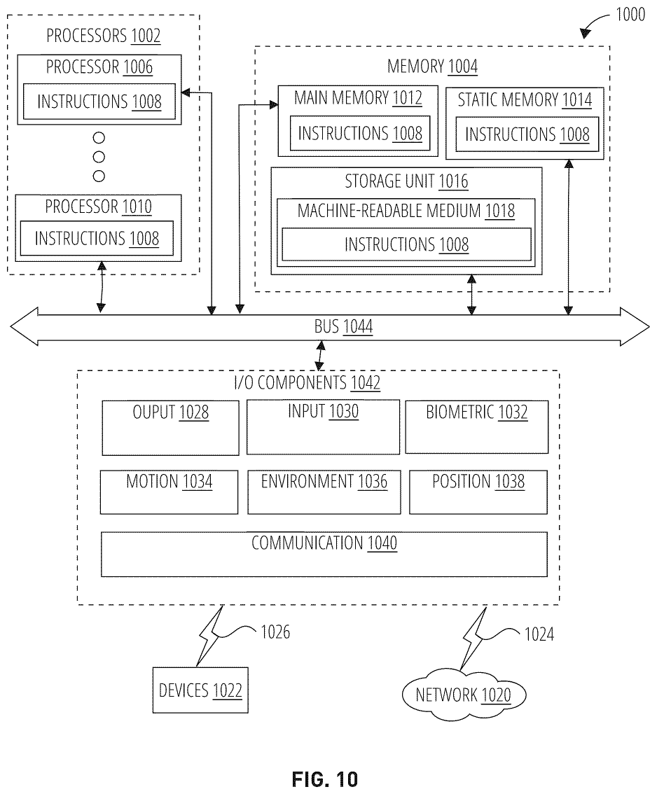

Any of the systems or machines (e.g., databases, devices, servers) shown in or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other programs) to perform one or more of the functions described herein for that system or machine. For example, a special-purpose computer system able to implement any one or more of the methodologies described herein is discussed below with respect to FIG. 10, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or machines illustrated in FIG. 1 may be combined into a single system or machine, and the functions described herein for any single system or machine may be subdivided among multiple systems or machines. Additionally, any number and types of client device 106 may be embodied within the network environment 100. Furthermore, some components or functions of the network environment 100 may be combined or located elsewhere in the network environment 100. For example, some of the functions of the client device 106 may be embodied at the application server 116.

FIG. 2 is a block diagram illustrating the marketplace application 122 that, in one example embodiment, are provided as part of the network environment 100. The marketplace application 122 may be hosted on dedicated or shared server machines (not shown) that are communicatively coupled to enable communications between or among server machines. The marketplace application 122 themselves are communicatively coupled (e.g., via appropriate interfaces) to each other and to various data sources, so as to allow information to be passed between or among the marketplace application 122 or so as to allow the marketplace application 122 to share and access common data. The marketplace application 122 may furthermore access one or more databases 128 via the database servers 124.

The application server 116 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace application 122 is shown to include at least one publication application 202 and one or more auction application 204, which support auction-format listing and price setting mechanisms (e.g., English, Dutch, Vickrey, Chinese, Double, Reverse auctions, etc.). The auction application 204 may also provide a number of features in support of such auction-format listings, such as a reserve price feature whereby a seller may specify a reserve price in connection with a listing and a proxy-bidding feature whereby a bidder may invoke automated proxy bidding.

A fixed-price application 206 supports fixed-price listing formats (e.g., the traditional classified advertisement-type listing or a catalog listing) and buyout-type listings. Specifically, buyout-type listings (e.g., including the Buy-It-Now (BIN) technology developed by eBay Inc., of San Jose, California) may be offered in conjunction with auction-format listings and allow a buyer to purchase goods or services, which are also being offered for sale via an auction, for a fixed price that is typically higher than the starting price of the auction.

A listing creation application 208 allows sellers to conveniently authorize listings pertaining to goods or services that they wish to transact via the application servers 104, and listing management application 210 allows sellers to manage such listings. Specifically, where a particular seller has authored and/or published a large number of listings, the management of such listings may present a challenge. The listing management application 210 provides a number of features (e.g., auto-relisting, inventory level monitors, etc.) to assist the seller in managing such listings. The post-listing management application 212 also assists sellers with a number of activities that typically occur post-listing.

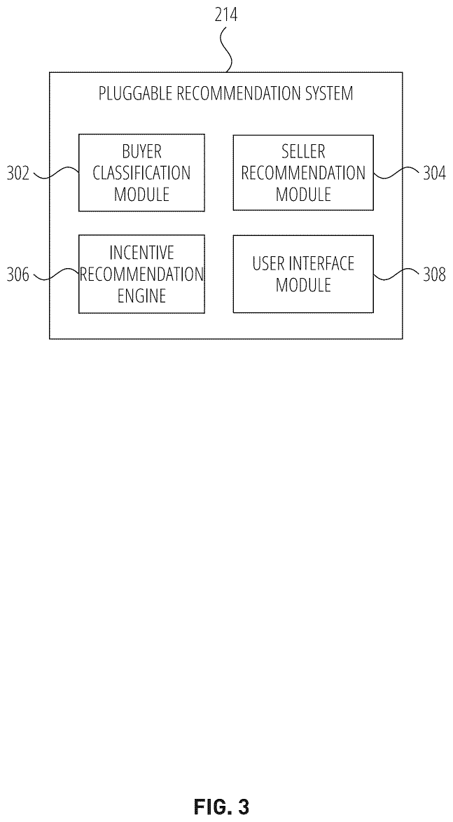

A pluggable recommendation system 214 enables a user (e.g., a seller) to leverage buyer interest and intent signals. In one example embodiment, the pluggable recommendation system 214 includes a buyer classifier, an offer recommendation provider, a recommendation engine, and a user interface (UI) Component. The buyer classifier identifies and categorizes buyers based on their responses to discounts. The offer recommendation provider analyzes seller and listing data to identify interested buyers and determine optimal discount offers. The recommendation engine consists of an event consumer, service client, and storage, with the ability to plug in providers via events or services to manage the lifecycle of recommendations, including enabling/disabling, ranking, and storage. The UI component includes a pluggable component for consistent seller experience across different applications (e.g., mobile interface, web-based interface). The pluggable recommendation system 214 is described in more detail below with respect to FIG. 3.

It should be noted that the term “web browser,” as used in this disclosure, shall be interpreted broadly to cover any application capable of displaying item attributes and rendering images from a web server. As such, this may include traditional web browsers as well as stand-alone applications (or apps) operating on mobile or other devices. For example, the web browser could be a traditional web browser such as Internet Explorer from Microsoft Corp., a stand-alone app such as a shopping application, a video player app, etc.

In another example where the web browser is a stand-alone app, it may be operating on, for example, a mobile device having a display and a camera. The techniques described herein could, therefore, be applied to an image obtained by the mobile device from an outside source, such as via the Internet, an image previously stored on the mobile device, or an image taken by the camera on the mobile device, potentially in real-time. Indeed, the techniques described herein can be applied to any device that is capable of obtaining a digital image and transmitting portions of that digital image to another device. Mobile devices are certainly one example, but others are possible as well, such as wearables and head-mounted devices.

FIG. 3 is a block diagram illustrating the pluggable recommendation system 214, in accordance with one example embodiment. The pluggable recommendation system 214 comprises a buyer classification module 302, a seller recommendation module 304, an incentive recommendation engine 306, and a user interface module 308.

The buyer classification module 302 analyzes and processes user-related data points to categorize users based on their likelihood to respond to incentives. For example, the buyer classification module 302 implements algorithms to analyze multiple signals including historical response data, viewing patterns, watchlist additions, cart activities, and buyer-seller relationships. In one example, the buyer classification module 302 utilizes heuristic-based computing with defined thresholds for each signal type and includes guardrails to prevent overwhelming users with recommendations.

In one example embodiment, the buyer classification module 302 processes multiple types of buyer-related signals and data points, including:
Historical discount response data
Buyer viewing patterns and frequency
Multiple views within defined time periods
Watchlist additions
Cart activities
Buyer-seller relationship data (such as following sellers)
Historical bidding patterns with specific sellers

The classification process employs a heuristic-based computing approach where each signal type has its own defined threshold for triggering classification. For example, the module considers:
Multiple item views within a 24-hour period
Cart additions within the last 15 days
Historical response patterns to previous offers

The buyer classification module 302 incorporates protective guardrails to prevent overwhelming buyers with excessive offers. These guardrails include:
Cooling-off periods between offers to the same buyer
Threshold requirements for each signal type
Time-based restrictions on offer frequency

One feature of the buyer classification module 302 is its extensible signal mechanism, allowing for:
Addition of new interest signals without system restructuring
Integration of emerging buyer behavior patterns
Seamless incorporation of new classification criteria

The buyer classification module 302 also implements urgency signal processing capabilities, though currently in development, which will:
Classify buyers based on the likelihood to purchase within specific timeframes
Prioritize recent activities (like 24-48 hour watchlist or cart additions)
Weight recent interactions more heavily than older activities

The seller recommendation module 304 aggregates eligible items and generates targeted recommendations for sellers. In one example, the seller recommendation module enables the creation of automated rules for managing large inventories and identifies items with a high likelihood of offer acceptance based on buyer interest signals.

In one example embodiment, the seller recommendation module 304 implements several technical capabilities:
Aggregates all eligible items for a seller and recommends offers across multiple selling points
Identifies items with a high likelihood of offer acceptance based on buyer interest signals
Enables sellers to create automated rules for managing large inventories

The seller recommendation module 304 processes seller inventory data through:
Periodic analysis of listings where buyers have expressed interest signals
Application of guardrails and thresholds to identify optimal recommendation opportunities
Aggregation of items to enable single-click actions across multiple listings

For sellers with large inventories (typically over 100 items), the seller recommendation module 304 provides advanced rule-creation capabilities:
Allows definition of category-specific rules
Enables price range-based filtering
Provides automated offer generation based on defined criteria

The seller recommendation module 304 includes feedback mechanisms that:
Show sellers how many buyers match their defined rules
Display the total number of eligible listings
Provide real-time updates on rule effectiveness

This seller recommendation module 304 continuously identifies opportunities for sellers to:
Enhance listing quality
Increase sales velocity
Prioritize recommendations based on seller needs and potential impact on transaction volume

The incentive recommendation engine 306 centralizes the processing and management of recommendations and handles the lifecycle management of recommendations, including enabling/disabling, ranking, and storage. In another example, the incentive recommendation engine 306 integrates with various data sources through events or services.

In one example embodiment, the incentive recommendation engine 306 implements several technical capabilities:
Consists of an event consumer, service client, and storage Components that work together to process and manage recommendations
Enables pluggable integration of providers through events or services
Manages the complete lifecycle of recommendations, including enabling, disabling, ranking, and storage functions

The incentive recommendation engine 306 processes recommendation data through multiple channels:
Consumes real-time events through event bridge systems
Processes batch data from data warehouse systems
Verifies recommendation validity through real-time API calls to prevent delayed or invalid recommendations

For recommendation management, the incentive recommendation engine 306 provides:
Configuration capabilities for different recommendation types
Ranking mechanisms to prioritize recommendations
Dismiss (snooze) configuration settings with customizable time periods
Adopt (sleep) configuration options for different recommendation types

The incentive recommendation engine 306 incorporates data handling mechanisms:
Leverages GraphQL APIs for summary and entity management
Provides APIs for snooze and adoption actions
Maintains recommendation storage and retrieval capabilities

The incentive recommendation engine 306 also implements automated lifecycle management features:
Tracks engagement and conversion metrics
Updates recommendation membership based on engagement data
Adjusts recommendation interfaces based on user group membership

The user interface module 308 provides a pluggable banner component that can be integrated across different platforms to maintain a consistent user experience across web-based and native applications. In another example, the user interface module 308 handles different call-to-action behaviors and updates automatically without requiring backend integration

In one example embodiment, the user interface module 308′s technical capabilities include:
Integration across different native device operating systems without requiring custom coding for each platform
Consistent display of recommendations across web-based pages, native iOS and Android applications, and HTML-based emails
Automatic handling of different Call-To-Action (CTA) behaviors without backend integration requirements

The user interface module 308 implements several display features:
Recommendation cards showing targeted offers and actions
Numerical indicators displaying counts of eligible items and interested buyers
Customizable message templates for different recommendation types

The user interface module 308 provides interactive functionality through:
Action buttons for sending offers, dismissing recommendations, or snoozing notifications
Customizable discount templates with percentage and value options
Automated offer setup interfaces for large inventory management

For consistency across platforms, the user interface module 308:
Uses a GraphQL-based interface to ensure uniform data presentation
Maintains visual consistency through a micro-frame architecture
Enables seamless integration across different seller hub pages

The user interface module 308 incorporates lifecycle management features that allow users to:
Dismiss recommendations temporarily through snooze actions
Adopt recommendations through customizable templates
Track engagement metrics for optimization.

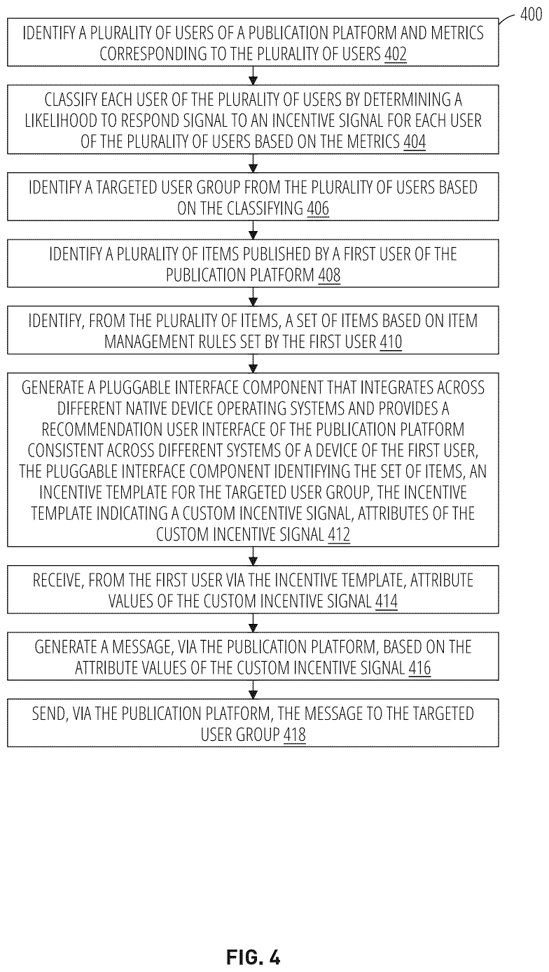

FIG. 4 is a flow diagram illustrating a method for a pluggable recommendation system, in accordance with another example embodiment. Although the example routine 400 depicts a particular sequence of operations, the sequence may be altered without departing from the scope of the present disclosure. For example, some of the operations depicted may be performed in parallel or in a different sequence that does not materially affect the function of the routine 400. In other examples, different components of an example device or system that implements the routine 400 may perform functions at substantially the same time or in a specific sequence.

According to some examples, the method includes identifying a plurality of users of a publication platform and metrics corresponding to the plurality of users at block 402. Block 402 involves gathering multiple types of user interaction data, including historical discount response patterns, buyer viewing behaviors, watchlist additions, cart activities, buyer-seller relationships, and historical bidding patterns. The system processes these metrics to establish baseline user behavior patterns that will be used for subsequent classification and targeting. The metrics collected include specific data points such as multiple views within defined time periods (e.g., 24-hour periods), cart additions within specific timeframes (e.g., 15 days), and historical responses to previous offers.

According to some examples, the method includes classifying each user of the plurality of users by determining a likelihood to respond signal to an incentive signal for each user of the plurality of users based on the metrics at block 404. This classification step employs algorithms to analyze multiple data signals, including historical discount response patterns, viewing behaviors, cart activities, and buyer-seller relationships. The system applies heuristic-based computing with defined thresholds for each signal type—for example, considering multiple views within a 24-hour period or cart additions within 15 days—to determine response likelihood. The classification process incorporates protective guardrails and cooling-off periods to prevent overwhelming users with recommendations while maintaining system efficiency. This step results in users being categorized and segmented into groups based on their calculated likelihood to respond to targeted discount strategies.

According to some examples, the method includes identifying a targeted user group from the plurality of users based on the classification at block 406. After users have been classified according to their likelihood to respond to signals, the system identifies specific groups of users who demonstrate the highest probability of responding to incentives. This targeting process leverages the previously determined classification data, including response likelihood signals, historical engagement patterns, and buyer behavior metrics, to create focused groups for targeted recommendations. The system applies defined thresholds and guardrails to ensure the targeted group selection maintains optimal engagement levels while preventing recommendation fatigue. This step creates strategically segmented user groups that will receive customized incentive signals through the platform's recommendation system.

According to some examples, the method includes identifying a plurality of items published by a first user (seller) of the publication platform at block 408. This step involves gathering the complete inventory of items that a seller has listed on the platform, which can range from individual items to large inventories containing hundreds or thousands of listings. For sellers with substantial inventories (e.g., over 100 items), the system processes the entire catalog of published items to prepare for subsequent rule-based filtering and recommendation generation. This identification step establishes the complete set of items that will be evaluated against buyer interest signals and seller-defined rules in subsequent steps.

According to some examples, the method includes identifying, from the plurality of items, a set of items based on item management rules set by the first user at block 410. For sellers with large inventories (typically over 100 items), the system enables the creation of customized rules such as category-specific filters, price range parameters, and other criteria to automatically identify eligible items. These rules can be configured to automatically select items that fall within specific categories and price ranges, with the system providing immediate feedback on how many items match the defined criteria and the number of potential buyers across those items. This filtering process helps sellers efficiently manage large inventories by automatically identifying items that meet their specified criteria for targeted offers, rather than requiring manual review of individual listings.

According to some examples, the method includes generating a pluggable interface Component that integrates across different native device operating systems and provides a recommendation user interface of the publication platform consistent across different systems of a device of the first user, the pluggable interface Component identifying the set of items, an incentive template for the targeted user group, the incentive template indicating a custom incentive signal, attributes of the custom incentive signal at block 412. This component integrates across different native device operating systems and creates a unified recommendation user interface that maintains consistency regardless of the system being used. The pluggable interface identifies the previously determined set of items and presents an incentive template specifically designed for the targeted user group. The template includes customizable elements such as the custom incentive signal and its associated attributes, allowing sellers to configure specific discount parameters and messaging. The interface Component leverages a GraphQL-based architecture to ensure uniform data presentation and seamless integration across different seller hub pages, native applications, and HTML-based emails, while maintaining independence from backend systems to enable efficient deployment with minimal technical overhead.

According to some examples, the method includes receiving, from the first user via the incentive template, attribute values of the custom incentive signal at block 414. Through the pluggable interface, sellers can input specific parameters for their offers, such as discount percentages, price ranges, and customized messaging for their targeted buyer groups. For sellers managing large inventories, this step allows them to define attribute values that will automatically apply to items matching their predefined rules, while sellers with smaller inventories can set specific values for individual or groups of items. The system captures these seller-defined attribute values through the template interface, which maintains consistency across different platforms while enabling customization of the incentive parameters that will be used to generate targeted messages to potential buyers.

According to some examples, the method includes generating a message via the publication platform based on the attribute values of the custom incentive signal at block 416. The system uses seller-defined parameters, such as discount percentages, price ranges, and custom messaging, to create targeted communications that will be sent to the identified buyer groups. For automated rules, the system generates messages that align with the seller's predefined criteria while maintaining consistency across different platforms and interfaces. The message generation process incorporates customized incentive parameters and templates to create personalized offers that reflect the seller's specified discount strategies and communication preferences.

According to some examples, the method includes sending, via the publication platform, the message to the targeted user group at block 418. The system delivers customized incentive offers through multiple channels, including web-based pages, native applications, and HTML-based emails, maintaining consistency across different platforms. For automated rules-based offers, the system continues to send messages to new interested buyers who match the targeting criteria until either the items are sold or the automation duration expires. The messages appear to buyers through various touchpoints, including homepage notifications and checkout pages, allowing them to view and respond to the targeted offers.

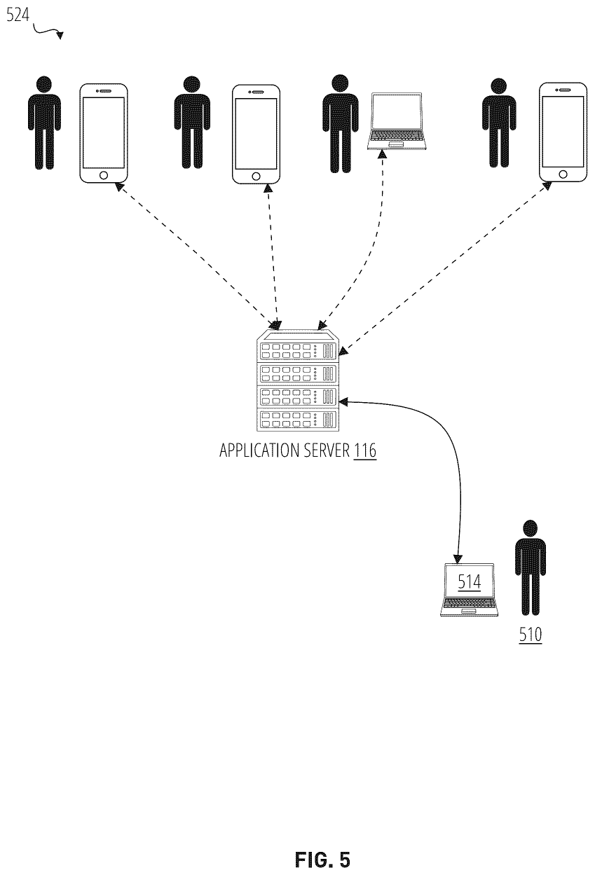

FIG. 5 is a block diagram illustrating an example operation of the pluggable recommendation system, in accordance with one example embodiment. FIG. 5 illustrates interactions between a seller 510 (via a seller's client device 514), application server 116, and targeted buyers 524 for configuring custom incentive signals through the recommendation interface.

The seller 510 interacts with a recommendation user interface that is provided by the application server 116 through the pluggable interface component. This interface maintains consistency across different platforms while enabling customization of incentive parameters.

Through the interface, the user 510 enters attribute values for the custom incentive signal via an incentive template. These attribute values include, for example:
Discount percentages or amounts
Custom messaging for buyers
Duration of the offer
Rules for automated offer management

The application server 116 receives these attribute values through the template interface. The pluggable recommendation system 214 processes these values against predefined rules to automatically identify eligible items. Based on the received attribute values, the pluggable recommendation system 214 generates targeted messages for the identified buyer groups (e.g., targeted buyers 524). The message generation incorporates:
The seller's specified discount parameters
Customized messaging
Applicable rules and guardrails
Platform-specific formatting requirements

The pluggable recommendation system 214 then initiates the process of delivering these messages to the targeted user group (targeted buyers 524) through various channels while maintaining consistent presentation across different platforms.

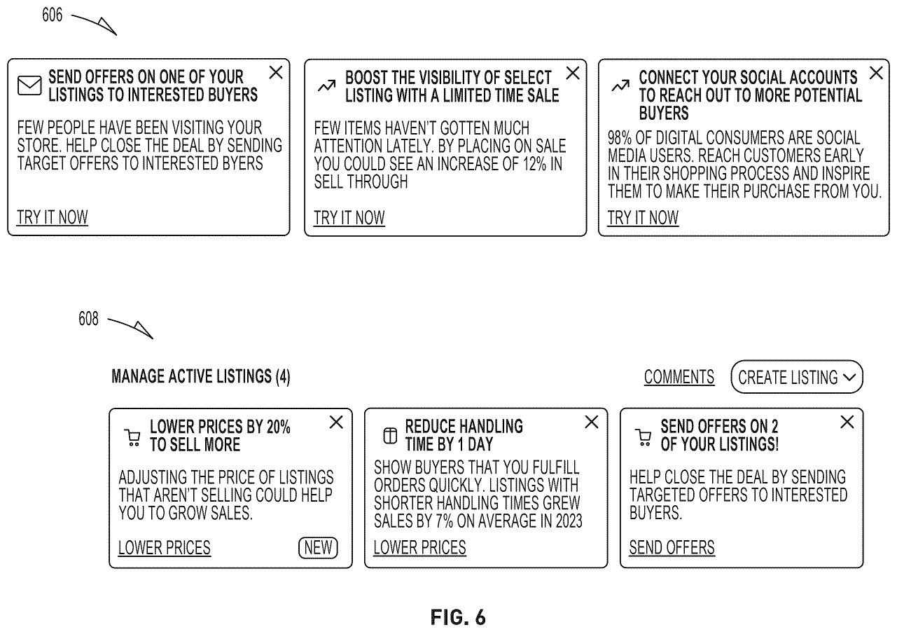

FIG. 6 illustrates examples of banner user interfaces that demonstrate the pluggable recommendation system's consistent presentation across the platform. FIG. 6 shows multiple banner cards 606 and 608 displaying different types of recommendations and opportunities for sellers to engage with potential buyers. Banners 606 include specific calls to action such as “Send offers on one of your listings to interested buyers,” “Boost the visibility of select listings with a limited time sale,” and options to connect social accounts. Each banner provides contextual information and potential benefits, such as indicating that “Few people have been visiting your store” and suggesting actions like sending targeted offers to interested buyers with a “Try it now” button. The interface also displays performance metrics, showing potential improvements such as “increase of 12% in sell through” for certain actions, and includes options for sellers to manage their recommendations through actions like dismissal or snoozing.

Banner 608 includes other examples of recommendations on managing active listings.

The banners maintain a consistent visual style and interaction pattern across different sections of the seller interface, and provide the pluggable nature of the recommendation system that can be integrated across various seller hub pages.

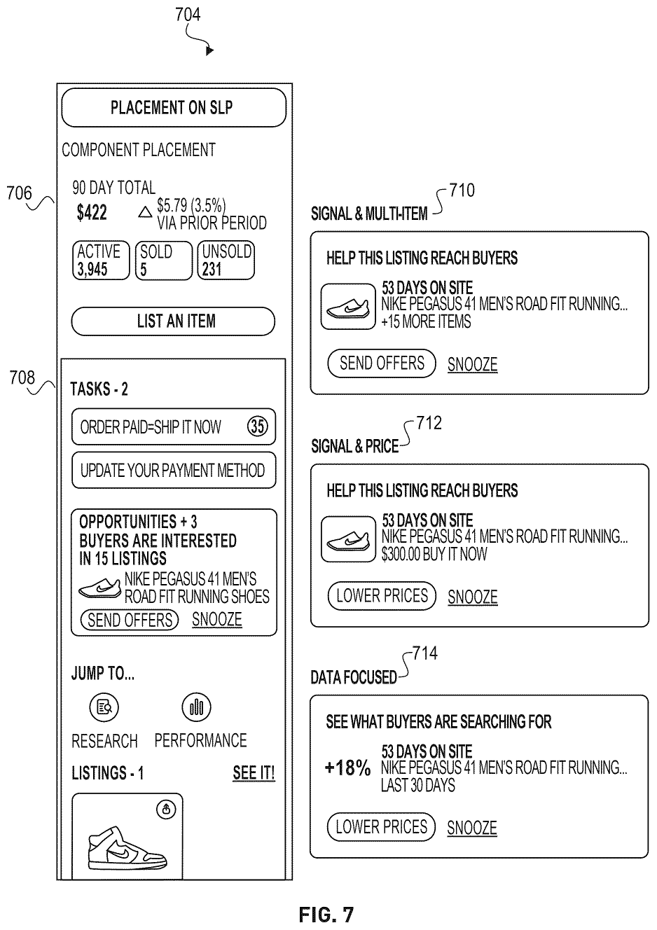

FIG. 7 illustrates a user interface in accordance with one example embodiment. For example, FIG. 7 illustrates the native view implementation of the seller recommendations interface 704, showing how the pluggable recommendation system maintains consistency across different platform views. FIG. 7 displays multiple sections including:

A header section 706 showing key metrics and statistics, such as “90 DAY TOTAL $422” with performance indicators and inventory status (Active: 3,945, Sold: 5, Unsold: 231).

An opportunity section 708 presents targeted recommendations to the seller, including a notification that “Buyers are interested in 15 listings.” As such, the system aggregates buyer interest signals across multiple items to present consolidated recommendations.

Multiple recommendation cards showing different types of actions the seller can take, including:
Signal and multi-item recommendation card 710 for helping listings reach buyers
Signal and price card 712 provides suggestions for adjusting prices
Data focused card 714 provides data-focused insights about buyer searching patterns

Each recommendation card includes action buttons like “Send offers” and “Snooze,” implementing the lifecycle management functionality that allows sellers to interact with recommendations. The interface maintains consistent interaction patterns across different views while adapting to the native platform's visual style.

FIG. 7 also shows how the system integrates buyer interest signals by displaying specific item details, such as “53 DAYS ON SITE” for particular listings, helping sellers make informed decisions about when to take action.

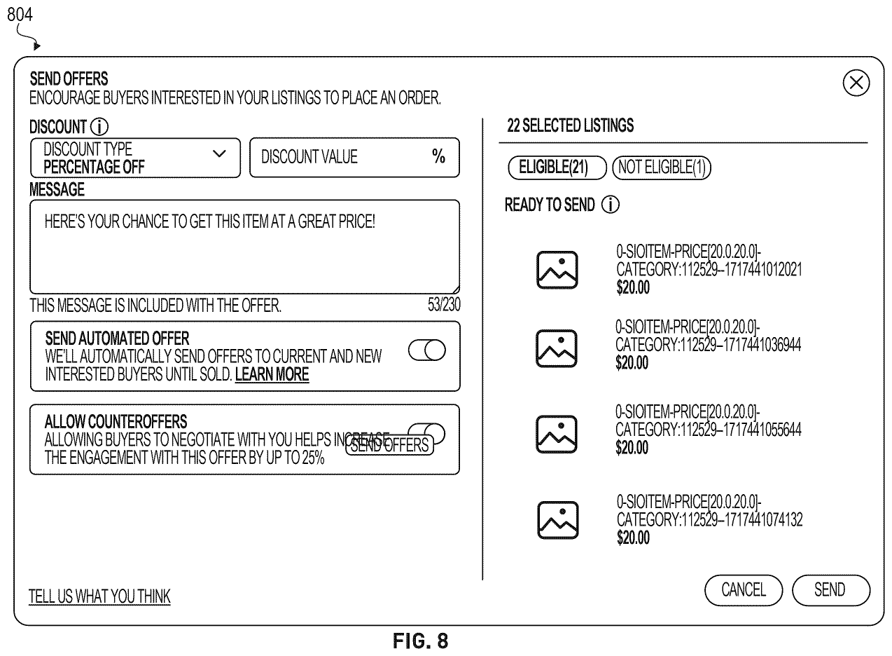

FIG. 8 illustrates a message user interface (template interface 804) in accordance with one example embodiment. For example, FIG. 8 illustrates the detailed interface for sending offers to interested buyers through the pluggable recommendation system. The interface displays several components:

A header section titled “Send offers” explains the purpose: “Encourage buyers interested in your listings to place an order.”

A discount configuration section that includes:
A dropdown menu for selecting discount type (showing “Percentage off”)
A field for entering the discount value as a percentage
A count of selected listings (showing “22 selected listings”)
Eligibility indicators showing “Eligible(21)” and “Not eligible(1)”

A customizable message section containing default text “Here's your chance to get this item at a great price!” with a character counter showing “53/230.”

An automated offer option that allows sellers to “automatically send offers to current and new interested buyers until sold,” demonstrating the system's capability to automate ongoing offer management.

A counteroffer toggle option that includes engagement statistics, noting that “allowing buyers to negotiate with you helps increase the engagement with this offer by up to 25%”

A listing section showing individual items with their details, including price information (e.g., “$20.00”) and category information.

Action buttons at the bottom include “Cancel,” “Send,” and a feedback option “Tell us what you think.”

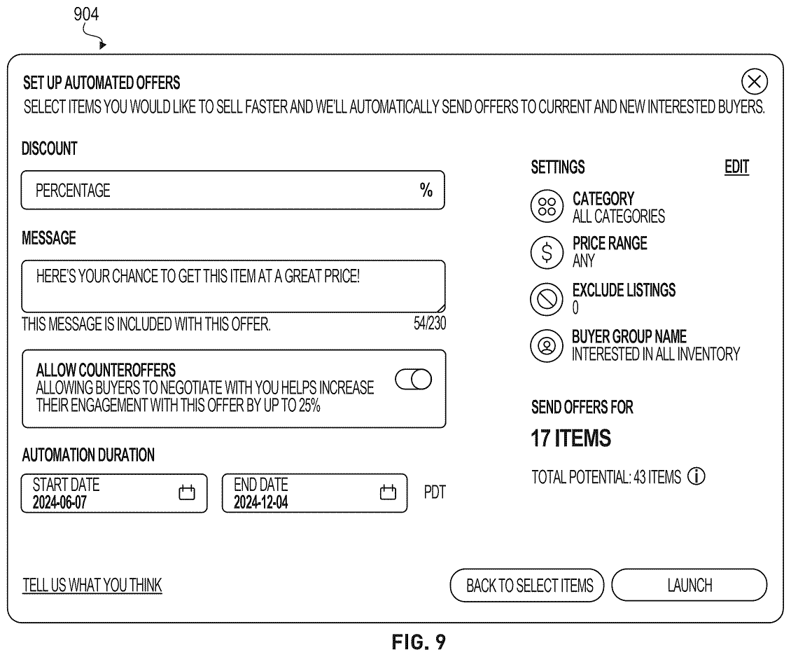

FIG. 9 illustrates a message user (template interface 904) in accordance with one example embodiment. For example, FIG. 9 illustrates the automated offers setup interface of the pluggable recommendation system, showing a detailed configuration panel for sellers to establish automated offer rules. The interface contains the following components:

A header section titled “Set up automated offers” explains the purpose: “Select items you would like to sell faster and we'll automatically send offers to current and new interested buyers.”

A discount configuration section including:
Percentage-based discount input field
Category selection dropdown defaulted to “All categories”
Price range filter options
Option to exclude specific listings

A customizable message section with:
Default text “Here's your chance to get this item at a great price!”
Character counter showing “54/230”
Counteroffer toggle with engagement statistics noting that allowing negotiations can “increase their engagement with this offer by up to 25%”

Automation duration controls featuring:
Start date field (showing “2024 Jun. 7”)
End date field (showing “2024 Dec. 4”)
Time zone indicator (PDT)

Offer scope information displaying:
“Send offers for 17 items”
“Total potential: 43 items”
Buyer group identification as “Interested in All inventory”

Action buttons including:
“Back to select items”
“Launch”
“Tell us what you think” Feedback Option.

FIG. 10 is a diagrammatic representation of the machine 1000 within which instructions 1008 (e.g., software, a program, an application, an applet, an app, or other executable code) for causing the machine 1000 to perform any one or more of the methodologies discussed herein may be executed. For example, the instructions 1008 may cause the machine 1000 to execute any one or more of the methods described herein. The instructions 1008 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1008, sequentially or otherwise, that specify actions to be taken by the machine 1000. Further, while only a single machine 1000 is illustrated, the term “machine” shall also be taken to include a collection of machines that individually or jointly execute the instructions 1008 to perform any one or more of the methodologies discussed herein.

The machine 1000 may include Processors 1002, memory 1004, and I/O Components 1042, which may be configured to communicate with each other via a bus 1044. In an example embodiment, the Processors 1002 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a Processor 1006 and a Processor 1010 that execute the instructions 1008. The term “processor” is intended to include multi core processors that may comprise two or more independent processors (sometimes referred to as “cores”) that may execute instructions contemporaneously. Although FIG. 10 shows multiple Processors 1002, the machine 1000 may include a single processor with a single core, a single processor with multiple cores (e.g., a multi-core processor), multiple processors with a single core, multiple processors with multiples cores, or any combination thereof.

The memory 1004 includes a main memory 1012, a static memory 1014, and a storage unit 1016, both accessible to the Processors 1002 via the bus 1044. The main memory 1004, the static memory 1014, and storage unit 1016 store the instructions 1008 embodying any one or more of the methodologies or functions described herein. The instructions 1008 may also reside, completely or partially, within the main memory 1012, within the static memory 1014, within machine-readable medium 1018 within the storage unit 1016, within at least one of the Processors 1002 (e.g., within the processor's cache memory), or any suitable combination thereof, during execution thereof by the machine 1000.

The I/O Components 1042 may include a wide variety of Components to receive input, provide output, produce output, transmit information, exchange information, capture measurements, and so on. The specific I/O Components 1042 that are included in a particular machine will depend on the type of machine. For example, portable machines such as mobile phones may include a touch input device or other such input mechanisms, while a headless server machine will likely not include such a touch input device. It will be appreciated that the I/O Components 1042 may include many other components that are not shown in FIG. 10. In various example embodiments, the I/O Components 1042 may include output Components 1028 and input Components 1030. The output Components 1028 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input Components 1030 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O Components 1042 may include biometric Components 1032, motion Components 1034, environmental Components 1036, or position Components 1038, among a wide array of other Components. For example, the biometric Components 1032 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion Components 1034 include acceleration sensor components (e.g., accelerometer), gravitation sensor components, rotation sensor components (e.g., gyroscope), and so forth. The environmental Components 1036 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position Components 1038 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O Components 1042 further include communication Components 1040 operable to couple the machine 1000 to a network 1020 or devices 1022 via a coupling 1024 and a coupling 1026, respectively. For example, the communication Components 1040 may include a network interface component or another suitable device to interface with the network 1020. In further examples, the communication Components 1040 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1022 may be another machine or any of a wide variety of peripheral devices (e.g., a peripheral device coupled via a USB).

Moreover, the communication Components 1040 may detect identifiers or include Components operable to detect identifiers. For example, the communication Components 1040 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication Components 1040, such as location via Internet Protocol (IP) geolocation, location via Wi-Fi® signal triangulation, location via detecting an NFC beacon signal that may indicate a particular location, and so forth.

The various memories (e.g., memory 1004, main memory 1012, static memory 1014, and/or memory of the Processors 1002) and/or storage unit 1016 may store one or more sets of instructions and data structures (e.g., software) embodying or used by any one or more of the methodologies or functions described herein. These instructions (e.g., the instructions 1008), when executed by Processors 1002, cause various operations to implement the disclosed embodiments.

The instructions 1008 may be transmitted or received over the network 1020, using a transmission medium, via a network interface device (e.g., a network interface Component included in the communication Components 1040) and using any one of a number of well-known transfer protocols (e.g., hypertext transfer protocol (HTTP)). Similarly, the instructions 1008 may be transmitted or received using a transmission medium via the coupling 1026 (e.g., a peer-to-peer coupling) to the devices 1022.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

### EXAMPLES

Example 1 is a method comprising: identifying a plurality of users of a publication platform and metrics corresponding to the plurality of users; classifying each user of the plurality of users by determining a likelihood to respond signal to an incentive signal for each user of the plurality of users based on the metrics; identifying a targeted user group from the plurality of users based on the classifying; identifying a plurality of items published by a first user of the publication platform; identifying, from the plurality of items, a set of items based on item management rules set by the first user; generating a pluggable interface Component that integrates across different native device operating systems and provides a recommendation user interface of the publication platform consistent across different systems of a device of the first user, the pluggable interface Component identifying the set of items, an incentive template for the targeted user group, the incentive template indicating a custom incentive signal, attributes of the custom incentive signal; receiving, from the first user via the incentive template, attribute values of the custom incentive signal; generating a message, via the publication platform, based on the attribute values of the custom incentive signal; and sending, via the publication platform, the message to the targeted user group.

In Example 2, the subject matter of Example 1 includes, wherein the metrics comprise historical user response to discount historical data, number of buyer views, buyer item tag, multiple views within a limited time frame, a watchlist, a cart, a buyer following a seller of the publication platform, and a buyer's historically bid on a same seller.

In Example 3, the subject matter of Examples 1-2 includes, wherein classifying further comprises: categorizing buyers based on their likelihood to respond to discounts, wherein the buyers are classified and segmented into groups for targeted discount strategies.

In Example 4, the subject matter of Examples 1-3 includes, wherein determining the likelihood to respond signal comprises heuristic-based computing relative to each data signal and classifying a buyer's likelihood to buy within an upcoming time frame.

In Example 5, the subject matter of Examples 1-4 includes, wherein the item management rules are configured to enable a seller to create automated rules for managing an inventory of items published with the publication platform, to identify a second set of users from the plurality of users that match the automated rules, and to identify a second set of items that match the automated rules.

In Example 6, the subject matter of Example 5 includes, prioritizing recommendations based on seller-defined rules of the first user and a projected impact on an inventory volume.

In Example 7, the subject matter of Examples 1-6 includes, wherein the recommendation user interface comprises a banner with an incentive recommendation message.

In Example 8, the subject matter of Example 7 includes, wherein the pluggable interface Component comprises an automated lifecycle management that enables the first user to dismiss, snooze, or adopt the incentive recommendation message with tracking mechanisms to monitor engagement and conversion.

In Example 9, the subject matter of Example 8 includes, in response to sending, via the publication platform, the message to the targeted user group, tracking engagement metrics of users of the targeted user group; updating a membership of the targeted user group based on the engagement metrics; and adjusting the recommendation user interface based on the membership of the targeted user group.

In Example 10, the subject matter of Examples 1-9 includes, wherein the different systems of the device comprise different channels, native applications, native operating systems, and channels.

Example 11 is a computing apparatus comprising: a Processor; and a memory storing instructions that, when executed by the Processor, configure the apparatus to: identify a plurality of users of a publication platform and metrics corresponding to the plurality of users; classify each user of the plurality of users by determining a likelihood to respond signal to an incentive signal for each user of the plurality of users based on the metrics; identify a targeted user group from the plurality of users based on the classifying; identify a plurality of items published by a first user of the publication platform; identify, from the plurality of items, a set of items based on item management rules set by the first user; generate a pluggable interface Component that integrates across different native device operating systems and provides a recommendation user interface of the publication platform consistent across different systems of a device of the first user, the pluggable interface Component identifying the set of items, an incentive template for the targeted user group, the incentive template indicating a custom incentive signal, attributes of the custom incentive signal; receive, from the first user via the incentive template, attribute values of the custom incentive signal; generate a message, via the publication platform, based on the attribute values of the custom incentive signal; and send, via the publication platform, the message to the targeted user group.

In Example 12, the subject matter of Example 11 includes, wherein the metrics comprise historical user response to discount historical data, number of buyer views, buyer item tag, multiple views within a limited time frame, a watchlist, a cart, a buyer follow a seller of the publication platform, and a buyer's historically bid on a same seller.

In Example 13, the subject matter of Examples 11-12 includes, wherein classifying further comprises: categorize buyers based on their likelihood to respond to discounts, wherein the buyers are classified and segmented into groups for targeted discount strategies.

In Example 14, the subject matter of Examples 11-13 includes, wherein determining the likelihood to respond signal comprises heuristic-based compute relative to each data signal and classifying a buyer's likelihood to buy within an upcoming time frame.

In Example 15, the subject matter of Examples 11-14 includes, wherein the item management rules are configured to enable a seller to create automated rules for managing an inventory of items published with the publication platform, to identify a second set of users from the plurality of users that match the automated rules, and to identify a second set of items that match the automated rules.

In Example 16, the subject matter of Example 15 includes, wherein the instructions further configure the apparatus to: prioritize recommendations based on seller-defined rules of the first user and a projected impact on an inventory volume.

In Example 17, the subject matter of Examples 11-16 includes, wherein the recommendation user interface comprises a banner with an incentive recommendation message.

In Example 18, the subject matter of Example 17 includes, wherein the pluggable interface Component comprises an automated lifecycle management that enables the first user to dismiss, snooze, or adopt the incentive recommendation message with tracking mechanisms to monitor engagement and conversion.

In Example 19, the subject matter of Example 18 includes, wherein the instructions further configure the apparatus to: in response to sending, via the publication platform, the message to the targeted user group, track engagement metrics of users of the targeted user group; update a membership of the targeted user group based on the engagement metrics; and adjust the recommendation user interface based on the membership of the targeted user group.

Example 20 is a non-transitory computer-readable storage medium, the computer-readable storage medium including instructions that when executed by a computer, cause the computer to: identify a plurality of users of a publication platform and metrics corresponding to the plurality of users; classify each user of the plurality of users by determining a likelihood to respond signal to an incentive signal for each user of the plurality of users based on the metrics; identify a targeted user group from the plurality of users based on the classifying; identify a plurality of items published by a first user of the publication platform; identify, from the plurality of items, a set of items based on item management rules set by the first user; generate a pluggable interface Component that integrates across different native device operating systems and provides a recommendation user interface of the publication platform consistent across different systems of a device of the first user, the pluggable interface Component identifying the set of items, an incentive template for the targeted user group, the incentive template indicating a custom incentive signal, attributes of the custom incentive signal; receive, from the first user via the incentive template, attribute values of the custom incentive signal; generate a message, via the publication platform, based on the attribute values of the custom incentive signal; and send, via the publication platform, the message to the targeted user group.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

1. A method comprising:
identifying a plurality of users of a publication platform and metrics corresponding to the plurality of users;
classifying each user of the plurality of users by determining a likelihood to respond signal to an incentive signal for each user of the plurality of users based on the metrics;
identifying a targeted user group from the plurality of users based on the classifying;
identifying a plurality of items published by a first user of the publication platform;
identifying, from the plurality of items, a set of items based on item management rules set by the first user;
generating a pluggable interface component that integrates across different native device operating systems and provides a recommendation user interface of the publication platform consistent across different systems of a device of the first user, the pluggable interface component identifying the set of items and an incentive template for the targeted user group, the incentive template indicating a custom incentive signal and attributes of the custom incentive signal, wherein the pluggable interface component provides action buttons for sending offers, dismissing recommendations, or snoozing notifications, and updates a display with new recommendations across the different systems of the device without requiring backend integration;
receiving, from the first user via the incentive template, attribute values of the custom incentive signal;
generating a message, via the publication platform, based on the attribute values of the custom incentive signal; and
sending, via the publication platform, the message to the targeted user group.

2. The method of claim 1, wherein the metrics comprise historical user response to discount historical data, number of buyer views, buyer item tag, multiple views within a limited time frame, a watchlist, a cart, a buyer following a seller of the publication platform, and a buyer's historically bid on a same seller.

3. The method of claim 1, wherein classifying further comprises: categorizing buyers based on their likelihood to respond to discounts, wherein the buyers are classified and segmented into groups for targeted discount strategies.

4. The method of claim 1, wherein determining the likelihood to respond signal comprises heuristic-based computing relative to each data signal and classifying a buyer's likelihood to buy within an upcoming time frame.

5. The method of claim 1, wherein the item management rules are configured to enable a seller to create automated rules for managing an inventory of items published with the publication platform, to identify a second set of users from the plurality of users that match the automated rules, and to identify a second set of items that match the automated rules.

6. The method of claim 5, further comprising:
prioritizing recommendations based on seller-defined rules of the first user and a projected impact on an inventory volume.

7. The method of claim 1, wherein the recommendation user interface comprises a banner with an incentive recommendation message.

8. The method of claim 7, wherein the pluggable interface component comprises an automated lifecycle management that enables the first user to dismiss, snooze, or adopt the incentive recommendation message with tracking mechanisms to monitor engagement and conversion.

9. The method of claim 8, further comprising:
in response to sending, via the publication platform, the message to the targeted user group, tracking engagement metrics of users of the targeted user group;
updating a membership of the targeted user group based on the engagement metrics; and
adjusting the recommendation user interface based on the membership of the targeted user group.

10. The method of claim 1, wherein the different systems of the device comprise different channels, native applications, native operating systems, and channels.

11. A computing apparatus comprising:
a processor; and
a memory storing instructions that, when executed by the processor, configure the apparatus to:
identify a plurality of users of a publication platform and metrics corresponding to the plurality of users;
classify each user of the plurality of users by determining a likelihood to respond signal to an incentive signal for each user of the plurality of users based on the metrics;
identify a targeted user group from the plurality of users based on the classifying;
identify a plurality of items published by a first user of the publication platform;
identify, from the plurality of items, a set of items based on item management rules set by the first user;
generate a pluggable interface component that integrates across different native device operating systems and provides a recommendation user interface of the publication platform consistent across different systems of a device of the first user, the pluggable interface component identifying the set of items and an incentive template for the targeted user group, the incentive template indicating a custom incentive signal and attributes of the custom incentive signal, wherein the pluggable interface component provides action buttons for sending offers, dismissing recommendations, or snoozing notifications, and updates the display with new recommendations across the different systems of the device without requiring backend integration;
receive, from the first user via the incentive template, attribute values of the custom incentive signal;
generate a message, via the publication platform, based on the attribute values of the custom incentive signal; and send, via the publication platform, the message to the targeted user group.

12. The computing apparatus of claim 11, wherein the metrics comprise historical user response to discount historical data, number of buyer views, buyer item tag, multiple views within a limited time frame, a watchlist, a cart, a buyer follow a seller of the publication platform, and a buyer's historically bid on a same seller.

13. The computing apparatus of claim 11, wherein classifying further comprises:
categorize buyers based on their likelihood to respond to discounts, wherein the buyers are classified and segmented into groups for targeted discount strategies.

14. The computing apparatus of claim 11, wherein determining the likelihood to respond signal comprises heuristic-based compute relative to each data signal and classifying a buyer's likelihood to buy within an upcoming time frame.

15. The computing apparatus of claim 11, wherein the item management rules are configured to enable a seller to create automated rules for managing an inventory of items published with the publication platform, to identify a second set of users from the plurality of users that match the automated rules, and to identify a second set of items that match the automated rules.

16. The computing apparatus of claim 15, wherein the instructions further configure the apparatus to:
prioritize recommendations based on seller-defined rules of the first user and a projected impact on an inventory volume.

17. The computing apparatus of claim 11, wherein the recommendation user interface comprises a banner with an incentive recommendation message.

18. The computing apparatus of claim 17, wherein the pluggable interface component comprises an automated lifecycle management that enables the first user to dismiss, snooze, or adopt the incentive recommendation message with tracking mechanisms to monitor engagement and conversion.

19. The computing apparatus of claim 18, wherein the instructions further configure the apparatus to:
in response to sending, via the publication platform, the message to the targeted user group, track engagement metrics of users of the targeted user group;
update a membership of the targeted user group based on the engagement metrics; and
adjust the recommendation user interface based on the membership of the targeted user group.

20. A non-transitory computer-readable storage medium, the computer-readable storage medium including instructions that when executed by a computer, cause the computer to:
identify a plurality of users of a publication platform and metrics corresponding to the plurality of users;
classify each user of the plurality of users by determining a likelihood to respond signal to an incentive signal for each user of the plurality of users based on the metrics;
identify a targeted user group from the plurality of users based on the classifying;
identify a plurality of items published by a first user of the publication platform;
identify, from the plurality of items, a set of items based on item management rules set by the first user;
generate a pluggable interface component that integrates across different native device operating systems and provides a recommendation user interface of the publication platform consistent across different systems of a device of the first user, the pluggable interface component identifying the set of items and an incentive template for the targeted user group, the incentive template indicating a custom incentive signal and attributes of the custom incentive signal, wherein the pluggable interface component provides action buttons for sending offers, dismissing recommendations, or snoozing notifications, and updates the display with new recommendations across the different systems of the device without requiring backend integration;
receive, from the first user via the incentive template, attribute values of the custom incentive signal;
generate a message, via the publication platform, based on the attribute values of the custom incentive signal; and send, via the publication platform, the message to the targeted user group.
